(19) United States
(12) Patent Application Publication
(10) Pub. No.: US 2003/0222454 A1
(43) Pub. Date: Dec. 4, 2003

(54) Bias Binding

(76) Inventor: F. Baker Williams, South Gate, CA (US)

Correspondence Address: LACASSE & ASSOCIATES, LLC, 1725 DUKE STREET, SUITE 650, ALEXANDRIA, VA, 22314, US

(21) Appl. No.: 10/249,951

(22) Filed: May 21, 2003

Related U.S. Application Data
(60) Provisional application No. 60/382,279, filed on May 21, 2002.

(51) Int. Cl. B42D 1/00

(52) U.S. Cl. 281/21.1

(57) ABSTRACT

A bias binding system facilitates the filing, storage, and retrieval of rigid, tabular objects. The bend and living hinge holder design allows for the rigid, tabular objects to be scrolled and scanned easily for rapid retrieval. The bias binding system is manufactured from a thin plastic web that is capable of collapsing and expanding easily and that is loose enough to display identifying numbers or symbols on some or all of the objects. The binding can be completely or partially biased to any side to reveal object information. The bias binding system is also used as a storage system for CDs and their literature.

### CROSS REFERENCE TO RELATED APPLICATIONS

The present application claims the benefit of provisional patent application “Bias Binding,” Ser. No. 60/382,279, filed May 21, 2002.

### BACKGROUND OF INVENTION

1. Field of Invention

The present invention relates generally to the field of filing, storage, and retrieval of tabular objects. More specifically, the present invention is related to a biased binding method that allows facilitated insertion, viewing, and retrieval of rigid tabular objects.

2. Discussion of Prior Art

The filing, storing, and (later) retrieval of “tabular” objects is probably most well-known through the binding of paper pages, as illustrated in examples such as books, magazines, pamphlets, and catalogues. In each of these, the pages are bound tightly together. In spite of their tight binding, the pages can be quickly retrieved (found and read) by scrolling or scanning. Scrolling can be defined as the thumbing or riffling through the pages (of a bound object), therefore exposing a few page numbers at a time. Scanning, however, is defined as the judicious bending of many pages thereby exposing many page numbers simultaneously. Scrolling and scanning are rapid routes to rapid retrieval of pages.

Some tabular objects we file, store, and retrieve, however, are rigid (e.g., cardboard pages in a photo album), and can not be bent as easily as paper pages when bound tightly together. Scrolling and scanning of these rigid, tabular pages, therefore, does not provide an optimal or convenient solution for rapid retrieval of tabular objects. Tightly binded rigid pages can not be displaced laterally far enough to display, for example, identifying numbers or symbols on the pages. A system that provides a loose, bias binding method for rapid retrieval of rigid pages is not known.

U.S. Pat. No. 4,180,341 provides an example of a hinged binder assembly designed to be a pattern book for sample textile or rug cards. One edge of each card is engaged in a retaining rail, and the cards are retained in the rails by a bent-over edge strip. When the pattern book is closed, the retaining rails are disposed above one another like a book. It is illustrated that the rails and cards can be moved in translation so that the cards come into a part-overlapping or stepped relationship to one another. However, the reference fails to disclose a loose, flexible binding system that can be used to scan rigid, tabular objects.

U.S. Pat. No. 5,037,137 describes a file binder comprising a plurality of rigid binding members having slit openings oriented in one direction for holding file sheets. The binding members are connected together by a flexible hinge, which is preferably a plastic tape. The flexible hinge, however, does not allow for easy scrolling and scanning of the filed objects.

A binder system including a flexible spine is illustrated in U.S. Pat. No. 5,104,147. However, page support channels are used and adapted to receive and retain longitudinal edges of display sheets. The channels have male connector elements that are used to attach and maintain a connection of the pages with the spine.

U.S. Pat. No. 6,360,890 B1 provides a storage book having spine member for handling a plurality of object holders or disc holders. When the storage book is closed, the holders are in a generally parallel position. When opened, the disc holders partially overlap in a staggered relation to one another. The spine member, however, is not loose or flexible, and does not easily provide scrolling or scanning of the objects.

The prior art also reveals other well-known varieties of binding methods for filing and storing objects, such as multi-ring binders, snap binders (such as those use to hold looseleaf), “claw-like” binders, and spiral binders. These binding methods do not permit scanning and scrolling of rigid pages for rapid retrieval or a bias binding system. Whatever the precise merits, features, and advantages of the above cited references, none of them achieves or fulfills the purposes of the present invention.

### SUMMARY OF INVENTION

The present invention provides rapid filing, storage, and retrieval of tabular objects that are rigid. The bias binding system comprises a plurality of holders comprised of living hinges and bends that are designed to facilitate the process of locating objects in the binding system by biasing the holders in a direction. The binding system allows rapid retrieval of one or more objects by being loose enough to display (simultaneously) identifying numbers or symbols on some or all of the objects. In this way, the bias binding system facilitates the retrieval (scanning or scrolling) of the stored objects. The objects can also be easily removed from the binding system. Further, a method of making a holder that is part of a plurality of holders for a bias binding system is discussed. In the preferred embodiment, the binding system is used as a high-density storage system for compact discs (CDs) and their literature.

### BRIEF DESCRIPTION OF DRAWINGS

FIG. 1 illustrates a method of forming the holders of the bias binding system of the present invention.

FIG. 2 illustrates an enlarged profile of the web used for the binding system of the present invention before a bend is formed.

FIG. 3 illustrates a method of forming a bend in the web of the present invention.

FIG. 4 illustrates the preferred embodiment of the present invention in an extended position.

FIG. 5 illustrates the preferred embodiment of the present invention in a collapsed position.

FIG. 6 illustrates an alternate embodiment of the present invention in an extended position.

FIG. 7 illustrates the present invention in a collapsed position.

FIG. 8 illustrates the present invention in an expanded (biased) position.

FIG. 9 illustrates the present invention in both a collapsed and expanded (biased) position.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. Please note that the term “retrieval” can be broadly interpreted to include finding, searching, scanning, scrolling, viewing, locating, and/or equivalents thereof, and have been used interchangeably throughout this application.

The dimensions as listed in the description below are for illustrative purposes only and should not limit the scope of this invention. The bias binding system is used to file, store, and retrieve objects such as pages, cards, envelopes, textiles, cardboards, cases, etc., hereafter referred to as objects, that are rigid.

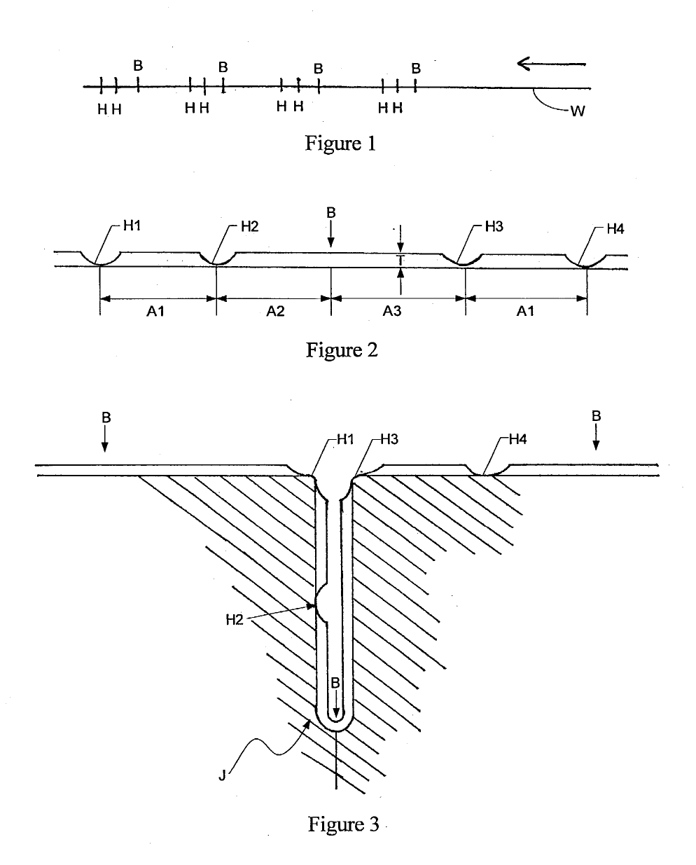

FIG. 1 illustrates a profile view of the preferred method of creating the holders of a bias binding system. Living hinges H are created along flexible web W from a roll of material with a defined space therebetween that will be used to create bend B. In the preferred embodiment, the material of web W used to form the complete bias binding system is a PETG (polyethylene terepthalate glycol) plastic sheet; however, any additional lightweight, loose, flexible material or plastic may also be used.

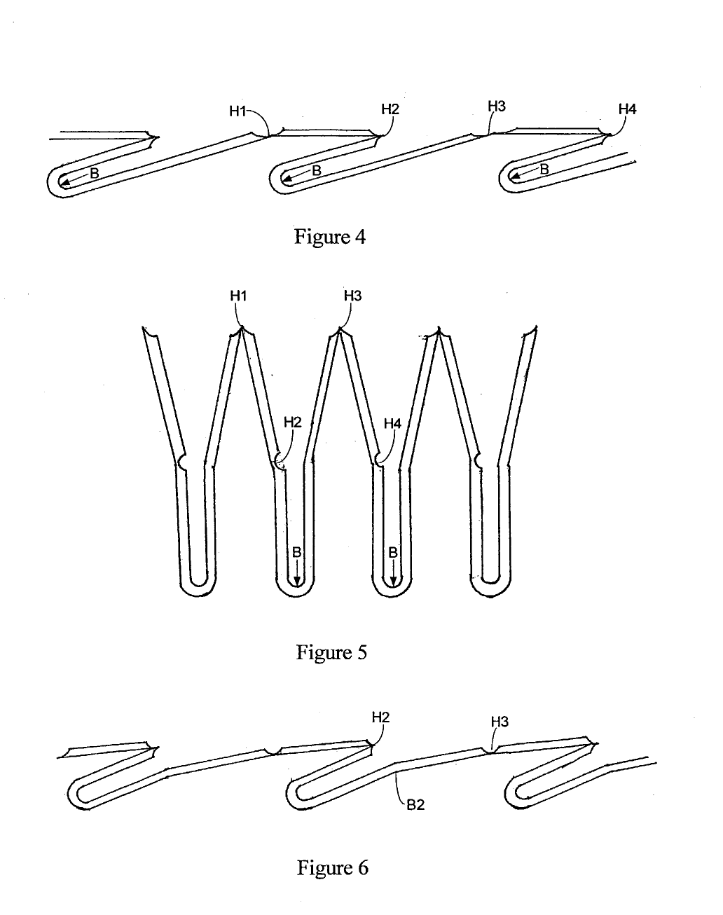

As seen in the enlarged profile of FIG. 2, living hinges H1 and H2 are created a defined distance A1 apart on web W of thickness T. Hinges are preferably stamped into the web; however other methods may also be used. Bend B is preferably created distance A2 from hinge H2, as discussed in further detail below. Hinge H3 is preferably created distance A3 from bend B. Hinge H4 is preferably created distance A1 from hinge H3. Hinge H4 is part of the next holder (see FIGS. 4 and 5), and is ideally equivalent to H2 of the next, adjacent holder. Hinges H1 or H3 may form a common hinge with an adjacent holder, as seen in FIG. 5. While plastics can vary in thickness and dimension, in the preferred embodiment, thickness T of web W is approximately 0.010 inches, and hinges H1, H2, H3, and H4 are stamped to a thickness of approximately 0.001 inches to enhance flexibility. Also, distances A1 and A2 are equal to 0.138 inches and distance A3 is equal to 0.276 inches.

FIG. 3 illustrates a method of forming bend B in order to form holder J in the web. Holder J is one of a plurality of holders that form the bias binding system. As previously mentioned, bend B is preferably created distance A2 from hinge H2. In the preferred embodiment, bend B is formed by using a heated blade (not shown). The heated blade descends into a slot between two chilled parts in order to create a 180 degree bend in web W. The heated blade is preferably 5 inches long and 0.018 inches thick. Further, other methods that form a similar bend B in web W may also be used. After bend B is formed, web W is collapsible into accordion-like folds.

FIG. 4 is an illustration of the binding of FIG. 3 in an expanded position. This system is designed to hold objects of uniform thickness. As seen in FIG. 4, bends B are created uniformly and allow for easy filing and removal of objects. Hinges H2 and H4 are relatively bent or completely biased to one side (in this illustration, to the left side). Biasing or moving the hinges relatively moves the holders in order to fully expand the binding system and to allow insertion, removal, and viewing of objects.

FIG. 5, however, illustrates a collapsed view of the bias binding system in FIGS. 3 and 4. When needed, objects in the binding system can be easily stacked parallel to or on top of one another (e.g., for storage). Here, hinges H2 and H4 are not bent or not biased to the side, but rather collapsed to make bends B and the objects that are being held parallel to one another.

FIG. 6 illustrates an alternative embodiment of the binding system of FIGS. 4 and 5, shown in an expanded position. As seen in FIG. 4, hinge H2 is bent or completely biased in order to expand the binding system. However, the binding in FIG. 6 is for objects that are thinner at the binding edge than the outer edge. That is, indent B2 is created between bend B and hinge H3. Indent B2 allows room for the objects that expand in width from the binding edge to be as easily filed, stored, and retrieved as other rigid, tabular objects.

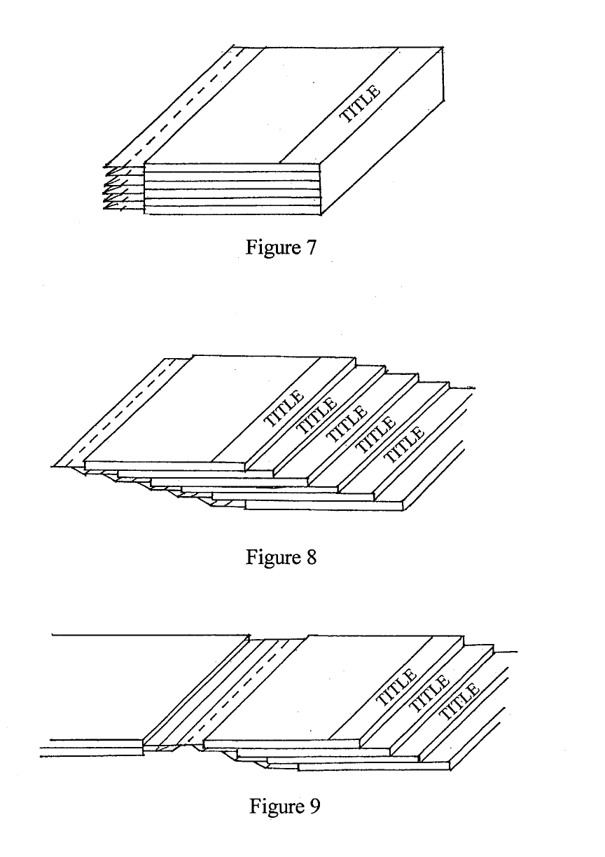

FIGS. 7, 8, and 9 illustrate a preferred working embodiment of a bias binding system that, for example, is intended to hold envelopes each containing a compact disc (CD), DVD, or optical disc, and its literature. In this embodiment, the binding system is partially biased, not symmetrical, in order to display only one side of the CD (or object). The bias binding allows for easy insertion and removal of objects, as well as quick retrieval through scanning and scrolling of the objects. In addition, the double hinge system maintains an accurate alignment of the objects, and is stable when it is fully expanded or fully collapsed. The use of the binding system as a CD holder provides an adequate example of how the partially biased system works.

As illustrated in FIG. 7, the binding system is collapsed for easy storage. For instance, a user would place CDs into an envelope having a description, graphics, literature, identifying numbers or symbols depicting the identity of the object it is holding (in our case, the title of the CD is along the edge). In a collapsed position, a user is only able to see the title of the first or top CD.

FIG. 8 illustrates an expansion of the binding system for easy viewing and scanning of information on the objects; in this instance, it allows for easy scanning of the titles of each of the CDs. The binding system is expanded (biased to one side) in order to allow for quick scanning and scrolling of all of the CD titles simultaneously. The user can bias the binding system in this way to quickly retrieve the CD of choice.

FIG. 9 illustrates an example of the binding system being both collapsed and biasly expanded. A user may know that a CD of choice is stored at the end of the binding system, but not the exact location of the CD. As shown, the user can then bias only a portion of the pages to allow for easy scanning and scrolling through a particular amount or through a certain area (the end) of the CD titles.

### CONCLUSION

A system and method has been shown in the above embodiments for the effective implementation of bias binding. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, it should be noted that the manufacturing of the bias binding system should not be limited to the above description and may be manufactured to fit objects (pages) of any reasonable size or thickness. Specific dimensions found in the specification are deemed approximate and may vary slightly from material to material and manufacturing processes. The binding may also be manufactured by assembling together, as by bonding or other ways of attachment, two or more components. The material used to form the binding system should not be limited to PETG plastic, but rather any material demonstrating similar lightweight, flexible properties for a loose binding system. The binding system can be manufactured to accommodate any number of objects, and may be mounted in a box or “book-like” case with provision for scrolling or scanning. The distance between the living hinges may be any defined distance. Also, the drawings show a system that may be biased to the left side in order to completely or partially expand the binding system. Although the drawings show a bias to the left, the binding system may also be completely or partially biased to the right. Finally, unequal arm slots may also be used with the binding system.

1. A bias binding system for the filing, storage, and retrieval of rigid, tabular objects comprising a plurality of holders, wherein each holder of said bias binding system comprises:
a first living hinge H1, a second living hinge H2, and a third living hinge H3, said hinges formed on a flexible web, and
a bend, said bend formed between hinges H2 and H3 for securely holding at least one of said objects,
said hinges H1 or H3, or a combination of H1 and H3, forming a common hinge with an adjacent holder, and
wherein relative movement among a set of said holders introduces a bias, said movement actuated by motion of hinges H1, H2, or H3 in each holder within said set of holders.

2. A bias binding system for the filing, storage, and retrieval of rigid, tabular objects as per claim 1, wherein said hinges are formed along said flexible web by stamping.

3. A bias binding system for the filing, storage, and retrieval of rigid, tabular objects as per claim 1, wherein said bends are formed by using a heated blade.

4. A bias binding system for the filing, storage, and retrieval of rigid, tabular objects as per claim 1, wherein said web is a PETG plastic sheet.

5. A bias binding system for the filing, storage, and retrieval of rigid, tabular objects as per claim 1, wherein the thickness of the web is about 0.010 inches and said hinges are formed along said flexible web by stamping and are stamped to a thickness of about 0.001 inches.

6. A bias binding system for the filing, storage, and retrieval of rigid, tabular objects as per claim 1, wherein the distance between H1 and H2 is about 0.138 inches.

7. A bias binding system for the filing, storage, and retrieval of rigid, tabular objects as per claim 1, wherein said bend is formed a distance of about 0.138 inches from H2.

8. A bias binding system for the filing, storage, and retrieval of rigid, tabular objects as per claim 1, wherein the distance between H3 and said bend is greater than the distance between H2 and said bend.

9. A bias binding system for the filing, storage, and retrieval of rigid, tabular objects as per claim 1, wherein H3 is formed a distance of about 0.276 inches from said bend.

10. A bias binding system for the filing, storage, and retrieval of rigid, tabular objects as per claim 1, wherein said bias extends or expands said binding system in any direction in order to reveal identifying information of said objects.

11. A bias binding system for the filing, storage, and retrieval of rigid, tabular objects as per claim 1, wherein said objects are biased partially in one direction.

12. A bias binding system for the filing, storage, and retrieval of rigid, tabular objects as per claim 1, wherein each holder further comprises an indent between said bend and H3.

13. A bias binding system for the filing, storage, and retrieval of rigid, tabular objects as per claim 1, wherein said objects are any of the following: CDs, DVDs, or optical discs.

14. A method of making a holder that is part of a plurality of holders for a bias binding system used for filing, storage, and retrieval of rigid, tabular objects, said method comprising:
forming a first living hinge H1, a second living hinge H2, and a third living hinge H3 on a flexible web, and
forming a bend between hinges H2 and H3, wherein bend forms a holder for securing at least one of said objects,
repeating the steps of forming said hinges and said bend along the length of said web to form said plurality of said holders, and
wherein a set of said holders introduces a bias based upon the movement actuated by motion of hinges H1, H2, or H3 in each holder within said set of holders.

15. A method of making a holder for a bias binding system for the filing, storage, and retrieval of rigid, tabular objects as per claim 14, wherein said hinges are formed along said flexible web by stamping.

16. A method of making a holder for a bias binding system for the filing, storage, and retrieval of rigid, tabular objects as per claim 14, wherein said bends are formed by using a heated blade.

17. A method of making a holder for a bias binding system for the filing, storage, and retrieval of rigid, tabular objects as per claim 14, wherein said web is a PETG plastic sheet.

18. A method of making a holder for a bias binding system for the filing, storage, and retrieval of rigid, tabular objects as per claim 14, wherein the thickness of the web is about 0.010 inches and said hinges are stamped to a thickness of about 0.001 inches.

19. A method of making a holder for a bias binding system for the filing, storage, and retrieval of rigid, tabular objects as per claim 14, wherein the distance between H1 and H2 is about 0.138 inches.

20. A method of making a holder for a bias binding system for the filing, storage, and retrieval of rigid, tabular objects as per claim 14, wherein said bend is formed a distance of about 0.138 inches from H2.

21. A method of making a holder for a bias binding system for the filing, storage, and retrieval of rigid, tabular objects as per claim 14, wherein the distance between H3 and said bend is greater than the distance between H2 and said bend.

22. A method of making a holder for a bias binding system for the filing, storage, and retrieval of rigid, tabular objects as per claim 14, wherein H3 is formed a distance of about 0.276 inches from said bend.

23. A method of making a holder for a bias binding system for the filing, storage, and retrieval of rigid, tabular objects as per claim 14, wherein said objects are any of the following: CDs, DVDs, or optical discs.

24. A method of using a bias binding system for the retrieval of one or more rigid, tabular objects comprising plurality of holders, wherein each holder comprises at least a first living hinge H1, a second living hinge H2, and a third living hinge H3, and a bend between hinges H2 and H3 for securely holding at least one of said objects, said hinges moving relatively in each holder among a set of said holders to introduce a bias, said method of use comprising:
identifying a biasing direction based upon an approximate location of identification information associated with at least one object, and
biasing a set of said holders in said biasing direction in order to view said identification information associated with at least one object.

25. A method of using a bias binding system for the retrieval of one or more rigid, tabular objects comprising plurality of holders as per claim 24, wherein said objects are any of the following: CDs, DVDs, or optical discs.
